(19) United States
(12) Patent Application Publication
(10) Pub. No.: US 2024/0405228 A1
(43) Pub. Date: Dec. 5, 2024

(54) ALKALINE DRY BATTERY

(71) Applicant: Panasonic Intellectual Property Management Co., Ltd., Kadoma-shi, Osaka (JP)

(72) Inventor: Yasufumi Takahashi, HYOGO KEN (JP)

(73) Assignee: Panasonic Intellectual Property Management Co., Ltd., Kadoma-shi, Osaka (JP)

(21) Appl. No.: 18/701,695

(22) PCT Filed: Oct. 12, 2022
(86) PCT No.: PCT/JP2022/037983

§ 371 Date: Apr. 16, 2024

(30) Foreign Application Priority Data
Oct. 20, 2021 (JP) 2021-171924

(51) Int. Cl. H01M 6/50; H01M 4/42; H01M 6/06; H01M 50/107; H01M 50/186

(52) U.S. Cl. CPC H01M 6/5038; H01M 4/42; H01M 6/06; H01M 50/107; H01M 50/186

(57) ABSTRACT

An alkaline dry battery includes: a bottomed cylindrical case including: a bottom portion having a positive electrode terminal portion; and a cylindrical side portion; a hollow cylindrical positive electrode in internal contact with the case; a negative electrode that is packed in a hollow portion of the positive electrode and contains a negative electrode active material containing zinc; a separator interposed between the positive electrode and the negative electrode; an alkaline electrolyte solution; and a sealing unit. The alkaline electrolyte solution is contained in the positive electrode, the negative electrode, and the separator. The sealing unit has a negative electrode terminal portion, and covers an opening of the case. An additive is packed in a gap between the negative electrode and the sealing unit and/or a gap between the negative electrode and the bottom portion. The additive contains a polyethylene glycol compound with a melting point of 46° C. or more.

### TECHNICAL FIELD

The present disclosure relates to an alkaline dry battery.

### BACKGROUND ART

An alkaline dry battery (alkaline manganese dry battery) is widely used because it has a capacity larger than that of a manganese dry battery and can provide a large current.

Patent Literature 1 discloses an alkaline zinc-manganese dioxide battery that contains mercury, wherein, in order to suppress a hydrogen generation reaction caused by contact between zinc and an electrolyte solution, the battery (an anode gel or a separator) contains a polyethylene glycol that has an average molecular weight of about 190 to 7000.

### CITATION LIST

### Patent Literature

[PTL 1] Laid-Open Patent Publication No. S48-43130

### SUMMARY OF INVENTION

### Technical Problem

There is a demand for an alkaline dry battery in which a temperature increase at the time of an external short circuit is suppressed and safety is further improved.

### Solution to Problem

One aspect of the present disclosure relates to an alkaline dry battery including: a bottomed cylindrical case that includes: a bottom portion that is equipped with a positive electrode terminal portion; and a cylindrical side portion; a hollow cylindrical positive electrode that is in internal contact with the case; a negative electrode that is packed in a hollow portion of the positive electrode and contains a negative electrode active material that contains zinc; a separator that is interposed between the positive electrode and the negative electrode; an alkaline electrolyte solution that is contained in the positive electrode, the negative electrode, and the separator; and a sealing unit that covers an opening of the case and is equipped with a negative electrode terminal portion, wherein an additive is packed in a gap between the negative electrode and the sealing unit and/or a gap between the negative electrode and the bottom portion, and the additive contains a polyethylene glycol compound that has a melting point of 46° C. or more.

### Advantageous Effects of Invention

According to the present disclosure it is possible to suppress a temperature increase at the time of an external short circuit in the alkaline dry battery.

Novel features of the present invention are set forth in the appended claims. However, the present invention will be well understood from the following detailed description of the present invention with reference to the drawings, in terms of both the configuration and the content together with other objects and features of the present invention.

### BRIEF DESCRIPTION OF DRAWINGS

FIG. 1 is a partial cross-sectional front view of an alkaline dry battery according to an embodiment of the present disclosure.

FIG. 2 is a partial cross-sectional front view of an alkaline dry battery according to another embodiment of the present disclosure.

### DESCRIPTION OF EMBODIMENT

Hereinafter, embodiments of the present disclosure will be described by way of examples. However, the present disclosure is not limited to the examples given below. In the following description, specific numerical values and materials may be listed as examples. However, other numerical values and materials may also be used as long as the advantageous effects of the present disclosure can be obtained. In the specification of the present application, the expression “a range of a numerical value A to a numerical value B” means that the range includes the numerical value A and the numerical value B, and can also be interpreted as “a numerical value A or more and a numerical value B or less”. In the following description, lower and upper limits of numerical values of specific physical properties, conditions, and the like will be shown. The lower limits and the upper limits shown below can be combined in any way as long as the lower limits are not greater than or equal to the upper limits. In the case where a plurality of materials are listed, only one material may be selected from among the plurality of materials, or a combination of two or more may be selected from among the plurality of materials.

An alkaline dry battery according to an embodiment of the present disclosure includes: a bottomed cylindrical case; a hollow cylindrical positive electrode that is in internal contact with the case; a negative electrode that is packed in a hollow portion of the positive electrode; a separator that is interposed between the positive electrode and the negative electrode; an alkaline electrolyte solution; and a sealing unit that covers an opening of the case. The case includes: a bottom portion that is equipped with a positive electrode terminal portion; and a cylindrical side portion. The negative electrode contains a negative electrode active material that contains zinc. The sealing unit is equipped with a negative electrode terminal portion. The alkaline electrolyte solution is contained in the positive electrode, the negative electrode, and the separator. An additive is packed in a gap between the negative electrode and the sealing unit and/or a gap between the negative electrode and the bottom portion of the case. The additive contains a polyethylene glycol compound (hereinafter also referred to as “compound A”) that has a melting point of 46° C. or more. The positive electrode terminal portion and the negative electrode terminal portion may also be referred to collectively as an “electrode terminal portion”.

The term “melting point” used above refers to, for example, a value obtained through measurement using an ordinary method specified in Japanese industrial standards (JIS K 0064) or the like.

When the battery temperature increases due to an external short circuit, the compound A starts to melt. As the compound A melts, heat generated by the external short circuit is absorbed. As a result, the temperature increase during the external short circuit is suppressed. Heat is likely to be generated in an area around the electrode terminal portion at the time of an external short circuit. Accordingly, as a result of the compound A being packed in the gap located near the electrode terminal portion, the temperature increase at the time of an external short circuit is efficiently suppressed. In the gap, the compound A can be packed in an amount required to suppress the temperature increase at the time of an external short circuit.

In the case where the additive is packed in either one of the gap between the negative electrode and the sealing unit (the gap located near the negative electrode terminal portion) and the gap between the negative electrode and the bottom portion of the case (the gap located near the positive electrode terminal portion), the effect of suppressing the temperature increase at the time of an external short circuit can be obtained. From the viewpoint of more remarkably obtaining the effect of suppressing the temperature increase at the time of an external short circuit, it is desirable that the additive is packed in the each of the gap between the negative electrode and the sealing unit and the gap between the negative electrode and the bottom portion of the case.

If the compound A is dispersed in the negative electrode, because the compound A is present relatively away from the electrode terminal portion, the endothermic effect obtained as a result of the compound A being melt may not be sufficiently exerted for the heat generated in the electrode terminal portion at the time of an external short circuit. Also, this configuration is disadvantageous in terms of discharge performance.

The compound A that has a melting point of 46° C. or more is present in a solid form when the battery is in normal use (during storage), and starts to melt when an external short circuit occurs. While the compound A is present in a solid form in the battery, diffusion of the compound A into the negative electrode is suppressed, and thus the packed compound A does not affect the discharge performance. The compound A may have a melting point of 50° C. or more. From the viewpoint of safety and reliability of the battery, the compound A may have a melting point of 46° C. or more (or 50° C. or more) and 90° C. or less, or 46° C. or more (or 50° C. or more) and 85° C. or less.

If the polyethylene glycol compound has a melting point of less than 46° C., the polyethylene glycol compound does not sufficiently melt at the time of an external short circuit, and thus the endothermic effect obtained as a result of the polyethylene glycol compound being melt may not be sufficiently exerted for the heat generated in the electrode terminal portion at the time of an external short circuit.

The compound A is a polymer that has an ethylene oxide backbone, and includes a polyethylene glycol and a derivative thereof. In the derivative of the polyethylene glycol, a hydrogen atom in the ethylene oxide (CH₂CH₂O) backbone may be replaced by another substituent. The substituent may be, for example, a halogen atom, a methyl group, an ethyl group, a hydroxyl group, or the like.

The compound A may have an average molecular weight of 7300 or more and 100000 or less, or 7300 or more and 30000 or less. In the specification of the present application, the average molecular weight of the compound A means the number average molecular weight of the compound A. The average molecular weight is determined based on gel permeation chromatography (GPC).

Specific examples of the polyethylene glycol compound that has a melting point of 46° C. or more include: product name PEG 6000 available from Kishida Chemical Co., Ltd. (with a melting point of 56 to 61° C. and an average molecular weight of 7300 to 9300); product name PEG 2000 available from Kishida Chemical Co., Ltd. (with a melting point of 49 to 53° C. and an average molecular weight of 1800 to 2200); product name PEG 4000 available from Kishida Chemical Co., Ltd. (with a melting point of 53 to 57° C. and an average molecular weight of 2700 to 3400); product name PEG 20000 available from Kishida Chemical Co., Ltd. (with a melting point of 56 to 64° C. and an average molecular weight of 18000 to 25000), and the like.

The amount of the compound A packed in the predetermined gap in the battery may be 1 mg or more and 200 mg or less, 50 mg or more and 200 mg or less, or 100 mg or more and 200 mg or less per gram of zinc derived from the negative electrode active material. When the amount of the compound A is within the above-described range, the compound A can be easily packed in the predetermined gap in the battery, and the effect of suppressing the temperature increase at the time of an external short circuit produced by the compound A is likely to be obtained.

The additive contains at least the compound A. That is, as the additive, only the compound A may be packed in the predetermined gap. The additive may contain an additional component other than the compound A. The additional component may be a component (for example, polytetrafluoroethylene) that enhances the binding force of the compound A in a solid form, and the component may be mixed with the compound A in a powder form. The additive packed in the predetermined gap in the battery may be in a powder form, a pellet form, or a heat-welded form. The additive in a pellet form can be obtained by, for example, subjecting the compound A in a powder form or a mixture of the compound A in a powder form and the additional component to press molding. The additive in a heat-welded form can be obtained by, for example, heating the compound A to a temperature greater than or equal to the melting point of the compound A, and heat-welding the melted compound A to a gasket or a base portion of a negative electrode current collector (the base portion being an exposed portion of the negative electrode current collector located in the gap between the negative electrode and the sealing unit).

Also, from the viewpoint of suppressing diffusion of the additive into the negative electrode and suppressing permeation of the electrolyte solution into the additive, a thin film (for example, a cellophane film) for partial shielding may be provided between the negative electrode and the additive.

Hereinafter, an alkaline dry battery according to the present embodiment will be described in detail with reference to the drawings. It is to be noted that the present disclosure is not limited to the embodiment given below. Also, modifications may be made as appropriate as long as the advantageous effects of the present invention are not impaired. Furthermore, the embodiment may also be combined with another embodiment.

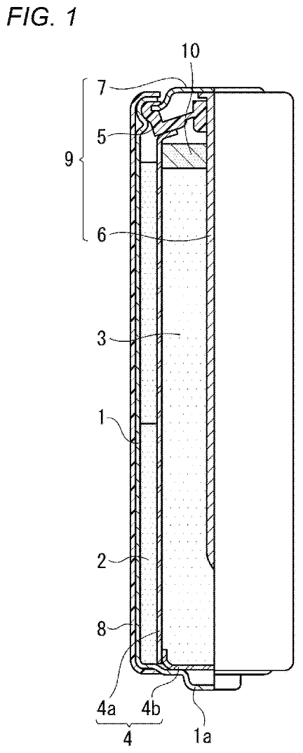

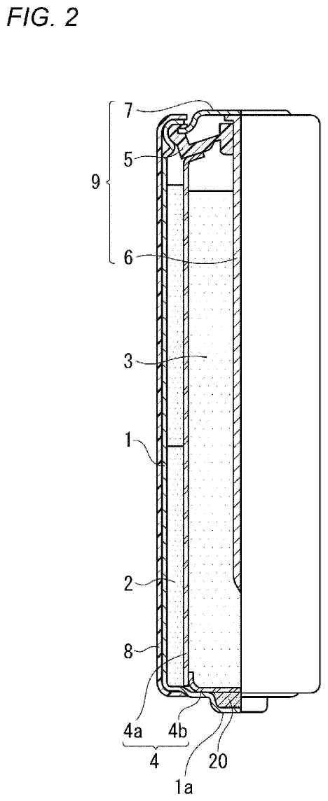

FIG. 1 is a front view of an alkaline dry battery according to an embodiment of the present disclosure, with a half of the alkaline dry battery being shown in a transverse cross section. FIG. 2 is a front view of an alkaline dry battery according to another embodiment of the present disclosure, with a half of the alkaline dry battery being shown in a transverse cross section. FIGS. 1 and 2 show examples of cylindrical batteries that have an inside-out structure. In FIG. 2, structural elements that are the same as those shown in FIG. 1 are given the same reference numerals.

As shown in FIG. 1, the alkaline dry battery includes a power generation element that includes a hollow cylindrical positive electrode 2, a gelled negative electrode 3 provided in a hollow portion of the positive electrode 2, a separator 4 interposed between the negative electrode 3 and the positive electrode 2, and an alkaline electrolyte solution (not shown). The power generation element is housed in a bottomed cylindrical metal case 1. A protruding portion 1a (a positive electrode terminal portion) is formed in a bottom portion of the case 1. The case 1 is made using, for example, a nickel-plated steel plate. The positive electrode 2 is provided in contact with an inner wall of the case 1. In order to enhance the adhesion properties of the contact between the positive electrode 2 and the case 1, the inner wall of the case 1 is preferably covered with a carbon coating film.

The bottomed cylindrical separator 4 includes a cylindrical separator 4a and a paper bottom 4b. The separator 4a is provided along an inner surface of the hollow portion of the positive electrode 2, and separates the positive electrode 2 and the negative electrode 3 from each other. Accordingly, the expression “a separator that is interposed between the positive electrode and the negative electrode” means the cylindrical separator 4a. The paper bottom 4b is placed on a bottom portion of the hollow portion of the positive electrode 2, and separates the negative electrode 3 and the case 1 from each other.

An opening portion of the case 1 is sealed with a sealing unit 9. The sealing unit 9 includes a resin gasket 5, a negative electrode terminal plate 7 (a negative electrode terminal portion), and a negative electrode current collector 6. A portion of the negative electrode current collector 6 is inserted in the negative electrode 3. The negative electrode current collector 6 is formed using a material such as, for example, an alloy of copper and zinc such as brass. The negative electrode current collector 6 may optionally be plated with tin. The negative electrode current collector 6 has a nail-shaped configuration that includes a head portion and a shank portion, the shank portion of the negative electrode current collector 6 is inserted in a through hole formed in a center cylindrical portion of the gasket 5, and the head portion of the negative electrode current collector 6 is welded to a flat portion of the negative electrode terminal plate 7 at a center thereof.

An opening end portion of the case 1 is crimped onto a flange portion along a circumferential edge portion of the negative electrode terminal plate 7 via an outer circumferential end portion of the gasket 5. An outer surface of the case 1 is covered with an exterior label 8.

In the alkaline dry battery of the present embodiment, an additive 10 that contains a compound A is packed in a gap between the gelled negative electrode 3 and the sealing unit 9 (the gap being formed by the negative electrode 3, the negative electrode current collector 6 (an exposed portion of the negative electrode current collector 6 exposed from the negative electrode 3), and the gasket 5). In order to reliably separate the positive electrode 2 and the negative electrode 3 from each other, an end portion of the separator 4a that is on the opening side of the case 1 is provided to protrude from end surfaces of the positive electrode 2 and the negative electrode 3 that are on the opening side of the case 1, and usually extends to a position where the end portion of the separator 4a abuts against the sealing unit 9 (the gasket 5) that is provided in the opening of the case 1. More specifically, it can also be said that the gap between the negative electrode 3 and the sealing unit 9 is a space surrounded by the negative electrode 3, the sealing unit 9 (the negative electrode current collector 6 and the gasket 5), and the separator 4a.

As a result of the additive 10 being packed in the gap near the negative electrode terminal plate 7, the endothermic effect obtained when the compound A contained in the additive 20 melts is efficiently exerted for the heat generated in an area around the negative electrode terminal plate 7 at the time of an external short circuit. The additive 10 may be packed as a ring-shaped pellet that contains the compound A. In this case, the shank portion of the negative electrode current collector 6 is provided in a hollow portion of the pellet. As a result, the additive 10 can be placed in the gap in a stable manner. Also, from the viewpoint of suppressing diffusion of the additive into the negative electrode and suppressing permeation of the electrolyte solution contained in the negative electrode into the additive, it is preferable that the additive 10 is packed as a pellet. The separator 4a that is adjacent to the additive 10 holds the electrolyte solution, and thus the electrolyte solution contained in the separator 4a is unlikely to permeate into the additive 10.

Also, as shown in FIG. 2, an additive 20 that contains a compound A may be packed in a gap between the gelled negative electrode 3 and the bottom portion of the case 1 (the gap being a void space portion formed by the protruding portion 1a that serves as the positive electrode terminal portion). As a result of the additive 20 being packed at a position adjacent to the bottom portion of the case 1, the endothermic effect obtained when the compound A contained in the additive 20 melts is efficiently exerted for the heat generated in an area around the bottom portion of the case 1 at the time of an external short circuit. The additive 20 may be in a powder form or a pellet form. Because the paper bottom 4b is interposed between the additive 20 and the negative electrode 3, the diffusion of the additive into the negative electrode is suppressed. The paper bottom 4 that is provided at a position adjacent to the additive 20 holds the electrolyte solution, and thus the electrolyte solution is unlikely to permeate into the additive 20.

The additive 20 shown in FIG. 2 may be packed together with the additive 10 shown in FIG. 1. From the viewpoint of suppressing diffusion of the additives into the negative electrode and suppressing permeation of the electrolyte solution into the additives, a thin film (for example, a cellophane film) for partial shielding may be provided between the gelled negative electrode 3 and the additive 10 and/or between the gelled negative electrode 3 and the additive 20 (at the position of the paper bottom 4b).

The positive electrode 2 contains manganese dioxide as a positive electrode active material and an electrolyte solution. As the manganese dioxide, it is preferable to use electrolytic manganese dioxide. The manganese dioxide is used in a powder form. From the viewpoint of easily ensuring ease of packing of the positive electrode, diffusibility of the electrolyte solution in the positive electrode, and the like, the manganese dioxide has an average particle size of, for example, 20 μm or more and 60 μm or less. From the viewpoint of moldability and suppressing expansion of the positive electrode, the manganese dioxide may have a BET specific surface area of, for example, 20 m²/g or more and 50 m²/g or less.

In the specification of the present application, the term “average particle size” refers to a 50% cumulative value (median diameter (D50)) in a volume-based particle size distribution. The average particle size is determined using, for example, a laser diffraction and/or scattering particle size distribution measurement apparatus. The term “BET specific surface area” refers to a specific surface area determined by measuring and calculating a surface area using the BET equation that is a theoretical equation for multilayer adsorption. The BET specific surface area can be determined through measurement using, for example, a specific surface area measurement apparatus based on a nitrogen adsorption method.

The positive electrode 2 may contain a conductive agent in addition to the manganese dioxide and the electrolyte solution. Examples of the conductive agent include a carbon black such as acetylene black and a conductive carbon material such as graphite. As the graphite, natural graphite, artificial graphite, or the like can be used. The conductive agent may be in a fibrous form or the like, but is preferably in a powder form. The average particle size of the conductive agent can be selected from, for example, a range of 5 nm or more and 50 μm or less. In the case where carbon black is used as the conductive agent, the average particle size of the conductive agent is preferably 5 nm or more and 40 nm or less. In the case where graphite is used as the conductive agent, the average particle size of the conductive agent is preferably 3 μm or more and 50 μm or less. The amount of the conductive agent in a positive electrode material mixture is, for example, 3 parts by mass or more and 10 parts by mass or less, and preferably 4 parts by mass or more and 8 parts by mass or less relative to 100 parts by mass of the manganese dioxide.

The positive electrode 2 can be obtained by, for example, press molding a positive electrode material mixture that contains a positive electrode active material, a conductive agent, and an electrolyte solution into a pellet. The positive electrode material mixture may be made into flakes or granules and optionally classified, and then press molded into a pellet. The pellet may be housed in a case, and then subjected to secondary pressing using a predetermined device such that the pellet adheres to the inner wall of the case. The manganese dioxide contained in the pellet in the positive electrode has an average density of, for example, 2.78 g/cm³ or more and 3.08 g/cm³ or less. The positive electrode (the positive electrode material mixture) may further contain an additional component (for example, polytetrafluoroethylene) as needed.

The negative electrode 3 is in a gelled form. That is, the negative electrode 3 usually contains a gelling agent in addition to the negative electrode active material and the electrolyte solution. The negative electrode active material contains zinc or a zinc alloy. The zinc alloy preferably contains at least one selected from the group consisting of indium, bismuth, and aluminum from the viewpoint of corrosion resistance.

The negative electrode active material is usually used in a powder form. From the viewpoint of ease of packing of the negative electrode and diffusibility of the alkaline electrolyte solution in the negative electrode, the negative electrode active material powder has an average particle size of, for example, 80 μm or more and 200 μm or less, and preferably 100 μm or more and 150 μm or less. The amount of the negative electrode active material powder in the negative electrode is, for example, 170 parts by mass or more and 220 parts by mass or less per 100 parts by mass of the electrolyte solution.

As the gelling agent, a known gelling agent used in the field of alkaline dry batteries can be used without a particular limitation. For example, a water-absorbent polymer or the like can be used. Examples of the gelling agent include polyacrylic acid and sodium polyacrylate. The amount of the gelling agent added is, for example, 0.5 parts by mass or more and 2 parts by mass or less per 100 parts by mass of the negative electrode active material.

As the separator 4, for example, a non-woven fabric or a microporous film is used. Examples of the material of the separator include cellulose, polyvinyl alcohol, and the like. As the non-woven fabric, for example, a non-woven fabric composed mainly of any of the above-listed materials is used. As the microporous film, a cellophane film or the like is used. The separator has a thickness of, for example, 80 μm or more and 300 μm or less. The separator may be formed by stacking a plurality of sheets (non-woven fabrics or the like) such that the separator has a thickness within the above-described range.

In FIG. 1, the bottomed cylindrical separator 4 is formed using a cylindrical separator 4a and a paper bottom 4b. However, the configuration is not limited thereto. As the separator, a bottomed cylindrical unitary separator may be used, or a separator with a known shape used in the field of alkaline dry batteries may be used.

As the electrolyte solution, for example, an aqueous solution of potassium hydroxide is used. The concentration of potassium hydroxide in the electrolyte solution is, for example, 30 mass % or more and 50 mass % or less. The electrolyte solution may further contain zinc oxide. The concentration of zinc oxide in the electrolyte solution is, for example, 1 mass % or more and 5 mass % or less.

### EXAMPLES

Hereinafter, the present disclosure will be described specifically based on examples and comparative examples. However, the present disclosure is not limited to the examples given below.

### Examples 1 to 4

In each example, an AA-size cylindrical alkaline dry battery (LR6) as shown in FIG. 1 was produced in the following procedure.

### (Production of Positive Electrode)

A mixture was obtained by mixing an electrolytic manganese dioxide powder (with an average particle size of 35 μm) as a positive electrode active material with a graphite powder (with an average particle size of 8 μm) as a conductive agent. The mass ratio between the electrolytic manganese dioxide powder and the graphite powder was set to 92.4:7.6. 1.5 parts by mass of an electrolyte solution was added to 100 parts by mass of the mixture, and the mixture was sufficiently stirred and then compression-molded into flakes to obtain a positive electrode material mixture. As the electrolyte solution, an alkaline aqueous solution containing potassium hydroxide (at a concentration of 35 mass %) and zinc oxide (at a concentration of 2 mass %) was used.

The positive electrode material mixture in the form of flakes was crushed into granules, and then classified using a 10 to 100 mesh sieve. The obtained granules were press-molded into a predetermined hollow cylindrical shape. In this way, two positive electrode pellets were produced.

### (Production of Negative Electrode)

A negative electrode active material, an electrolyte solution, and a gelling agent were mixed to obtain a gelled negative electrode 3. As the negative electrode active material, a zinc alloy powder (with an average particle size of 130 μm) containing 0.02 mass % of indium, 0.01 mass % of bismuth, and 0.005 mass % of aluminum was used. As the electrolyte solution, the same electrolyte solution used to produce the positive electrode was used. As the gelling agent, a mixture of crosslink-branched polyacrylic acid and highly-crosslinked linear sodium polyacrylate was used. The mass ratio between the negative electrode active material, the electrolyte solution, and the gelling agent was set to 100:50:1.

### (Assembly of Alkaline Dry Battery)

A carbon coating film (with a thickness of about 10 μm) was formed on the inner surface of a bottomed cylindrical case (with an outer diameter of 13.80 mm and a height of 50.3 mm) formed using a nickel-plated steel plate. In this way, a case 1 was obtained. Two positive electrode pellets were longitudinally inserted into the case 1, and then pressed to form a positive electrode 2, with the pellets adhering to the inner wall of the case 1. A bottomed cylindrical separator 4 was placed within the positive electrode 2. Then, an electrolyte solution was injected to impregnate the separator 4 with the electrolyte solution. As the electrolyte solution, the same electrolyte solution used to produce the positive electrode was used. The whole was left to stand in this state for a predetermined period of time to allow the electrolyte solution to permeate into the positive electrode 2 from the separator 4.

After that, a predetermined amount of the gelled negative electrode 3 was packed into the separator 4. An additive 10 was placed on the negative electrode 3. As the additive 10, a ring-shaped pellet obtained by press molding a polyethylene glycol compound in a powder form was used. As the polyethylene glycol compound, product name PEG 6000 available from Kishida Chemical Co., Ltd. was used. The packing amount of the polyethylene glycol compound (the amount of the polyethylene glycol compound per gram of zinc derived from the negative electrode active material) was set to a value shown in Table 1.

The separator 4 was formed using a cylindrical separator 4a and a paper bottom 4b. As the cylindrical separator 4a and the paper bottom 4b, a non-woven fabric sheet composed mainly of rayon fibers and polyvinyl alcohol fibers mixed at a mass ratio of 1:1 was used. The non-woven fabric sheet used as the paper bottom 4b had a thickness of 0.27 mm. As the separator 4a, a triple-wound separator formed by winding a 0.09 mm-thick non-woven fabric sheet in three layers was used.

A negative electrode current collector 6 was obtained by pressing ordinary brass (with a Cu content of about 65 mass % and a Zn content of about 35 mass %) into a nail shape, and then plating its surface with tin. A negative electrode terminal plate 7 made of a nickel-plated steel plate was electrically welded to a head portion of the negative electrode current collector 6. After that, a shank portion of the negative electrode current collector 6 was press fitted in a through hole of a resin gasket 5. In this way, a sealing unit 9 composed of the gasket 5, the negative electrode terminal plate 7, and the negative electrode current collector 6 was produced.

Next, the sealing unit 9 was provided in an opening portion of the case 1. At this time, the shank portion of the negative electrode current collector 6 was inserted into the negative electrode 3 via a hollow portion of the ring-shaped pellet (the additive 10). An opening end portion of the case 1 was crimped onto a circumferential edge portion of the negative electrode terminal plate 7 via the gasket 5, and an opening portion of the case 1 was thereby sealed. An outer surface of the case 1 was covered with an exterior label 8. In this way, an alkaline dry battery in which the additive was packed in the gap between the negative electrode and the sealing unit was produced. In Table 1, A1 to A4 represent batteries of Examples 1 to 4, respectively.

### Examples 5 and 6

Batteries A5 and A6 (batteries as shown in FIG. 2) of Examples 5 and 6 were produced in the same manner as the batteries A1 and A3 of Examples 1 and 3 were produced, except that, instead of the additive 10, a polyethylene glycol compound in a powder form was packed in a recess portion formed in the bottom portion of the case as an additive 20.

### Example 7

A battery A7 (a battery as shown in FIG. 1 in which an additive 20 was packed as shown in FIG. 2) of Example 7 was produced in the same manner as the battery A2 of Example 2 was produced, except that, in addition to the additive 10, a polyethylene glycol compound in a powder form was packed in a recess portion formed in the bottom portion of the case as an additive 20. The polyethylene glycol compound used as the additive 20 was the same as that used as the additive 10. The packing amount of the polyethylene glycol compound used as the additive 20 was set to a value shown in Table 1.

### Example 8

A battery A8 (a battery as shown in FIG. 1) of Example 8 was produced in the same manner as the battery A3 of Example 3 was produced, except that the additive 10 was packed by heating the polyethylene glycol compound to 70° C. and heat-welding the polyethylene glycol compound to a base portion of the negative electrode current collector (the base portion being an exposed portion of the negative electrode current collector located in the gap between the sealing unit and the negative electrode).

### Example 9

A battery A9 (a battery as shown in FIG. 1) of Example 9 was produced in the same manner as the battery A3 of Example 3 was produced, except that product name PEG 2000 available from Kishida Chemical Co., Ltd. was packed in the gap between the negative electrode and the sealing unit as the additive 10.

### Example 10

A battery A10 (a battery as shown in FIG. 1) of Example 10 was produced in the same manner as the battery A3 of Example 3 was produced, except that product name PEG 20000 available from Kishida Chemical Co., Ltd. was packed in the gap between the negative electrode and the sealing unit as the additive 10.

### Comparative Example 1

A battery X1 of Comparative Example 1 was produced in the same manner as the battery A1 of Example 1 was produced, except that no additive (no polyethylene glycol compound) was packed in the gap between the negative electrode and the sealing unit.

### Comparative Example 2

A battery X2 of Comparative Example 2 was produced in the same manner as the battery A5 of Example 5 was produced, except that the packing amount of the polyethylene glycol compound was changed to a value shown in Table 1, and product name PEG 600 (with a melting point of 18 to 22° C. and an average molecular weight of 570 to 630) available from Kishida Chemical Co., Ltd. was used as the polyethylene glycol compound.

### Comparative Example 3

A battery X3 of Comparative Example 3 was produced in the same manner as the battery A5 of Example 5 was produced, except that the packing amount of the polyethylene glycol compound was changed to a value shown in Table 1, and product name PEG 1000 (with a melting point of 35 to 39° C. and an average molecular weight of 950 to 1050) available from Kishida Chemical Co., Ltd. was used as the polyethylene glycol compound.

### Comparative Example 4

A battery X4 of Comparative Example 4 was produced in the same manner as the battery A2 of Example 2 was produced, except that no additive (no polyethylene glycol compound) was packed in the gap between the negative electrode and the sealing unit, and, in the production of the negative electrode, the same additive (the same polyethylene glycol compound) as that used in Example 2 was added to the gelled negative electrode to disperse the additive in the negative electrode.

### [Evaluation]

For each of the batteries produced above, the surface temperature of the battery (near a center of the case in a height direction of the case) during an external short circuit was measured to obtain the highest temperature.

The results of evaluation are shown in Table 1. In Table 1, the term “packing amount” refers to the amount (mg) of a polyethylene glycol compound packed per gram of zinc derived from the negative electrode active material contained in the negative electrode.

TABLE 1

| | Additive | | | | Evaluation |
|---|---|---|---|---|---|
| | Polyethylene glycol compound | | | | Highest battery surface |
| | | Melting point | Packing amount | | temperature during |
| Battery | Type | (° C.) | (mg) | Packing area | external short circuit |
| A1 | PEG 6000 | 56 to 61 | 1 | Gap between negative electrode and | 99 |
| A2 | PEG 6000 | 56 to 61 | 50 | sealing unit | 97 |
| A3 | PEG 6000 | 56 to 61 | 100 | | 92 |
| A4 | PEG 6000 | 56 to 61 | 200 | | 89 |
| A5 | PEG 6000 | 56 to 61 | 1 | Gap between negative electrode and | 99 |
| A6 | PEG 6000 | 56 to 61 | 100 | bottom of case | 93 |
| A7 | PEG 6000 | 56 to 61 | 50 | Gap between negative electrode and | 90 |
| | | | | sealing unit | |
| | | | 50 | Gap between negative electrode and | |
| | | | | bottom of case | |
| A8 | PEG 6000 | 56 to 61 | 100 | Gap between negative electrode and | 92 |
| | | | | sealing unit (fusion) | |
| A9 | PEG 2000 | 49 to 53 | 100 | Gap between negative electrode and | 95 |
| | | | | sealing unit | |
| A10 | PEG 20000 | 56 to 64 | 100 | Gap between negative electrode and | 93 |
| | | | | sealing unit | |
| X1 | No additive used | — | — | — | 102 |
| X2 | PEG 600 | 18 to 22 | 50 | Gap between negative electrode and | 101 |
| X3 | PEG 1000 | 35 to 39 | 50 | bottom of case | 101 |
| X4 | PEG 6000 | 56 to 61 | 50 | Within negative electrode | 101 |

In the batteries A1 to A10 in which a polyethylene glycol compound with a melting point of 46° C. or more was packed in the predetermined gap, the temperature increase during the external short circuit was suppressed, as compared with the batteries X1 to X4. In the batteries A1 to A10, a predetermined amount of the polyethylene glycol compound was packed in the gap near the electrode terminal portion, and thus the endothermic effect obtained as a result of the compound melting was efficiently exerted for the heat generated in the electrode terminal portion during the external short circuit.

In the battery X1, because no additive was packed, the battery temperature increased during the external short circuit. In the batteries X2 and X3, because a polyethylene glycol compound with a melting point of less than 46° C. was packed, the increase in the battery temperature during the external short circuit was not able to be suppressed. In the battery X4, because a polyethylene glycol compound was dispersed within the negative electrode, the polyethylene glycol compound was located away from the electrode terminal portion, as a result of which the endothermic effect obtained as a result of the compound melting was not sufficiently exerted for the heat generated in the electrode terminal portion during the external short circuit, and the increase in the battery temperature was not able to be suppressed. The battery X4 is also disadvantageous in terms of discharge performance.

### INDUSTRIAL APPLICABILITY

The alkaline dry battery according to the present disclosure is suitably used as, for example, a power source for a portable audio appliance, an electronic game machine, electric lighting equipment, or the like.

The present invention has been described in terms of the presently preferred embodiment, but the disclosure should not be interpreted as limiting. Various alterations and modifications will no doubt become apparent to those skilled in the art to which the present invention pertains, after having read the disclosure. Accordingly, it is to be understood that the appended claims be interpreted as covering all alterations and modifications which fall within the true spirit and scope of the present invention.

### REFERENCE SIGNS LIST

1: case
1a: protruding portion
2: positive electrode
3: negative electrode
4: bottomed cylindrical separator
4a: cylindrical separator
4b: paper bottom
5: gasket
6: negative electrode current collector
7: negative electrode terminal plate
8: exterior label
9: sealing unit
10, 20: additive

What is claimed is:

1. An alkaline dry battery comprising:
a bottomed cylindrical case that includes: a bottom portion that is equipped with a positive electrode terminal portion; and a cylindrical side portion;
a hollow cylindrical positive electrode that is in internal contact with the case;
a negative electrode that is packed in a hollow portion of the positive electrode and contains a negative electrode active material that contains zinc;
a separator that is interposed between the positive electrode and the negative electrode;
an alkaline electrolyte solution that is contained in the positive electrode, the negative electrode, and the separator; and
a sealing unit that covers an opening of the case and is equipped with a negative electrode terminal portion,
wherein an additive is packed in a gap between the negative electrode and the sealing unit and/or a gap between the negative electrode and the bottom portion, and
the additive contains a polyethylene glycol compound that has a melting point of 46° C. or more.

2. The alkaline dry battery in accordance with claim 1,
wherein the polyethylene glycol compound has an average molecular weight of 7300 or more and 100000 or less.

3. The alkaline dry battery in accordance with claim 1,
wherein the polyethylene glycol compound is contained in an amount of 1 mg or more and 200 mg or less per gram of zinc derived from the negative electrode active material.
